(19) United States
(12) Patent Application Publication
(10) Pub. No.: US 2026/0260116 A1
(43) Pub. Date: Sep. 3, 2026

(54) SYSTEMS AND METHODS FOR TRAINING MULTI-MODAL EMBEDDING MACHINE LEARNING MODELS FOR AUTONOMOUS VEHICLES

(71) Applicant: Torc Robotics, Inc., Blacksburg, VA (US)

(72) Inventors: Achyut Sarma Boggaram, Cedar Park, TX (US); Nicolas Jourdan, Darmstadt (DE)

(21) Appl. No.: 19/067,429

(22) Filed: Feb. 28, 2025

(51) Int. Cl. G06N 3/0895; B60W 50/00; B60W 60/00

(52) U.S. Cl. CPC G06N 3/0895; B60W 50/00; B60W 60/00; B60W 2420/403; B60W 2420/408

(57) ABSTRACT

A system and method for training a multi-modal embedding machine learning model of an autonomous vehicle is provided. The system is configured to train an embedding machine learning model of an autonomous vehicle in a self-supervised manner by receiving original sensor data including first sensor data of one or more first sensors of a first modality and second sensor data of one or more second sensors of a second modality and extracting, via the embedding machine learning model, original features based on the original sensor data. The system is further configured to train the embedding machine learning model in the self-supervised manner by applying perturbations to at least one of the original sensor data or the original features to derive perturbed data, and aligning the perturbed data with original data while adjusting the embedding machine learning model to optimize a loss function.

### TECHNICAL FIELD

The field of the disclosure relates generally to autonomous vehicles and, more specifically, to systems and methods for developing a multi-modal embedding machine learning model of an autonomous vehicle.

### BACKGROUND OF THE INVENTION

An autonomous vehicle relies on an autonomy computing system to perceive the environment in which the autonomous vehicle operates, control operation of the autonomous vehicle, and/or perform the operation of the autonomous vehicle. The autonomy computing system includes one or more machine learning models. To develop the machine learning models, large datasets are needed to train and test the performance of the machine learning models. The machine learning models typically include at least one supervised or semi-supervised machine learning model, where at least part of the development datasets needs to be annotated or labeled to provide ground truth for the learning. Labeling datasets, especially those datasets containing three-dimensional (3D) point clouds, such as point clouds acquired by Light Detection and Ranging (LiDAR) sensors, is labor intensive, time consuming, and demanding on the computer resources, such as memory and computation power. Multi-modal autonomous computing systems which receive data from sensors of multiple modalities also deal with large volumes of real-world noise, decreasing reliability in environments that are challenging for sensors, such as low-visibility environments, noisy environments, or reflective environments. Labeling multi-modal datasets also requires a great deal of duplicated work to label data separately from each modality for a given scene. Accordingly, it is desirable to have improved systems and methods for training multi-modal machine learning models that do not require manual labeling of data and improves machine learning models robustness and reliability in challenging environments.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a computer-implemented method for training a multi-modal embedding machine learning model of an autonomous vehicle is provided. The method include training the embedding machine learning model in a self-supervised manner by receiving original sensor data including first sensor data of one or more first sensors of a first modality and second sensor data of one or more second sensors of a second modality, the original sensor data being data of an environment in which the autonomous vehicle could be operating. The method further includes extracting, via the embedding machine learning model, original features based on the original sensor data. The method further includes training the embedding machine learning model in the self-supervised manner by applying perturbations to at least one of the original sensor data or the original features to derive perturbed data and aligning the perturbed data with original data while adjusting the embedding machine learning model to optimize a loss function, the original data including the original sensor data or the original features.

In another aspect, a autonomy system of an autonomous vehicle for training a multi-modal embedding machine learning model of an autonomous vehicle is provided. The system may include at least one processor in communication with at least one memory device. The at least one processor is configured to train an embedding machine learning model of an autonomous vehicle in a self-supervised manner by receiving original sensor data including first sensor data of one or more first sensors of a first modality and second sensor data of one or more second sensors of a second modality, the original sensor data being data of an environment in which the autonomous vehicle could be operating. The at least on processor is further configured to train the embedding machine learning model by extracting, via the embedding machine learning model, original features based on the original sensor data. The at least one processor is further configured to train the embedding machine learning model in the self-supervised manner by applying perturbations to at least one of the original sensor data or the original features to derive perturbed data and aligning the perturbed data with original data while adjusting the embedding machine learning model to optimize a loss function, the original data including the original sensor data or the original features.

In yet another aspect, a non-transitory computer-readable storage medium with instructions stored thereon is provided. The instructions, in response to execution by at least one processor, causes the at least one processor to train an embedding machine learning model of an autonomous vehicle in a self-supervised manner by receiving original sensor data including first sensor data of one or more first sensors of a first modality and second sensor data of one or more second sensors of a second modality, the original sensor data being data of an environment in which the autonomous vehicle could be operating. The instructions further cause the at least one processor to train the embedding machine learning model by extracting, via the embedding machine learning model, original features based on the original sensor data. The instructions further cause the at least one processor to train the embedding machine learning model in the self-supervised manner by applying perturbations to at least one of the original sensor data or the original features to derive perturbed data and aligning the perturbed data with original data while adjusting the embedding machine learning model to optimize a loss function, the original data including the original sensor data or the original features.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a flowchart showing an example method of training a multi-modal embedding machine learning model of an autonomous vehicle;

FIG. 3B is a flowchart of an embodiment of the method of FIG. 3A;

FIG. 3C is a flowchart of an example method of joint embedding in the method shown in FIG. 3B;

FIG. 3D shows a flowchart of an embodiment of the method of applying perturbations and aligning data shown in FIG. 3B;

FIG. 4A shows a flowchart of an example method of calculating a cross-modal loss function used in the method shown in FIG. 3B;

FIG. 4B shows a flowchart of an example method of calculating a temporal consistency loss used in the method shown in FIG. 3B;

FIG. 5 is a method flowchart showing an example method of training a multi-modal embedding machine learning model of an autonomous vehicle;

FIG. 6A is a schematic diagram of an example neural network model;

FIG. 6B is a schematic diagram of a neuron in the example neural network model shown in FIG. 6A;

FIG. 7 is a block diagram of an example computing device;

FIG. 8 is a block diagram of an example user computing device; and

FIG. 9 is a block diagram of an example server computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for training multi-modal embedding machine learning models are provided. Light detection and ranging (LiDAR), radar point cloud data, and camera data are described herein as examples for illustration purposes only. Systems and methods described herein may be applied to train a model using any types of point cloud and/or image data and sensor data of any modality. An autonomy computing system of an autonomous vehicle is used to detect features in the environment in which the autonomous vehicle operates, generate control policies based on the features, and execute the control policies to control operation of the autonomous vehicle. The autonomy computing system includes one or more machine learning models. In developing the machine learning models, a relatively large amount of training data is needed to reduce overfitting and/or underfitting of the models, and at least one machine learning model requires supervised or semi-supervised training, where ground truth or annotated or labeled data are needed in the training data. Besides the relatively large amount of data, manual labeling of point cloud data is presented with additional challenges due to the high dimensionality and intricacies involved in labeling data from multiple modalities, especially 3D data. Manually labeling point cloud data is therefore time-consuming, labor intensive, and costly.

Furthermore, machine learning models which include multi-modal systems face challenges with noise in real-world environments, including both spatial and temporal issues. Processing and labeling of multi-modal data present challenges for training models based on the data, including problems with the real-world noise, such as spatial problems with sensor alignment, temporal issues with frame order, and other temporal and/or spatial inconsistencies between data received from multiple different sensors of different modalities.

In contrast, systems and methods described herein address the above-described problems by training multi-modal embedding machine learning models using self-supervision to be resilient to temporal and spatial noise and/or anomalies without manual labeling. Elimination of manual labeling greatly reduces time and costs in producing labeled data for developing autonomous computing systems. Systems and methods described herein integrate multi-modal sensor data to produce a joint feature embedding. Embeddings or features refer to features detected by an embedding machine learning model based on sensor data. Spatial and temporal perturbations are applied to the original sensor data and applied to the joint feature embedding , producing perturbed data. Perturbations may be applied to features to derive perturbed data. The systems and methods described herein align the perturbed data with the original data, then adjust the feature embedding machine learning model to optimize one or more loss functions. Optimization of the loss function includes penalizing spatial discrepancies between feature embeddings of different modalities, and/or by penalizing temporal discrepancies between objects over time. In some embodiments, objects of higher importance are assigned higher weights in the loss function. Because the perturbations applied to the data are known by the system, the system and methods described herein are capable of adjusting the model in aligning the perturbed data with the original data to have increased resistance to real world noise without the need for manual labeling. This process saves the time and cost associated with manual labeling, while producing a model capable of handling multi-modal data that is resistant to both temporal and spatial noise. In addition, the systems and methods described herein are advantageous in increasing the efficiency in training the embedding machine learning model by using a loss function including a multi-modal consistency loss function, thereby eliminating duplicate training for individual modalities in at least some known methods.

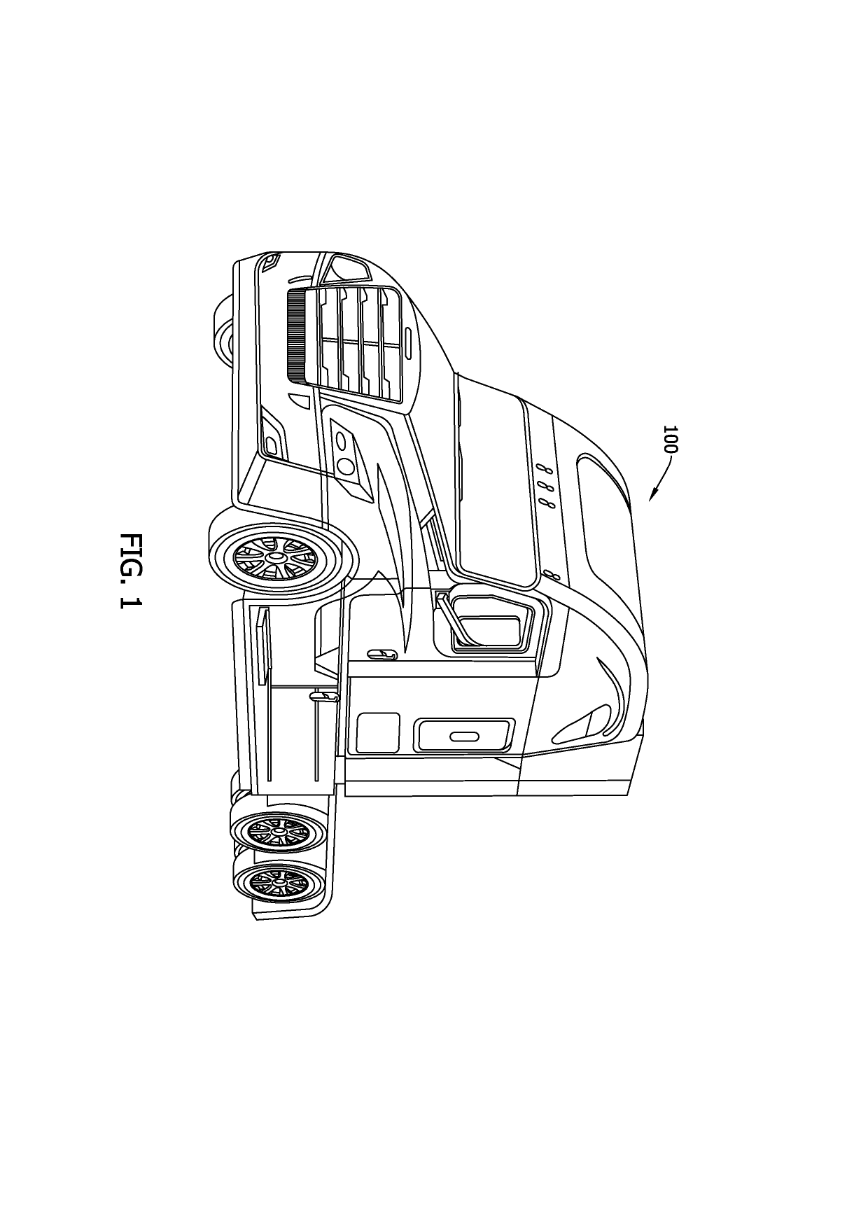

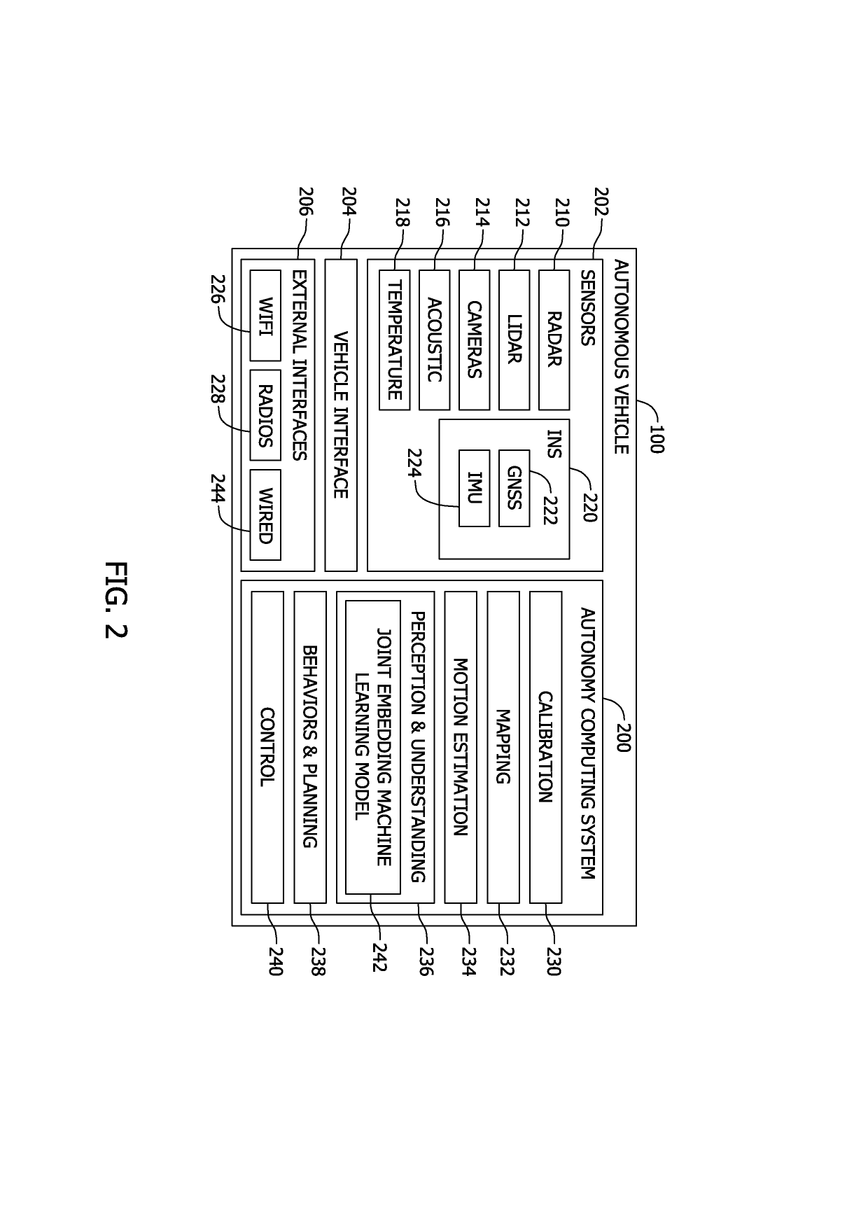

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and embedding machine learning model 242. Embedding machine learning model 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Embedding machine learning model 242 receives original sensor data of at least one modality. Embedding machine learning model 242 extracts original features from the original sensor data. For example, embedding machine learning model may receive original sensor data including first sensor data of one or more first sensors of a first modality and second sensor data of one or more second sensors of a second modality, the original sensor data being data of an environment in which the autonomous vehicle could be operating. Embedding machine learning model 242 extracts features from the original sensor data. Features include, for example, depth, semantic classification, velocity, duration of observation, and other features associated with original sensor data. Features may be represented as a feature vector with each feature represented by a numerical value.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

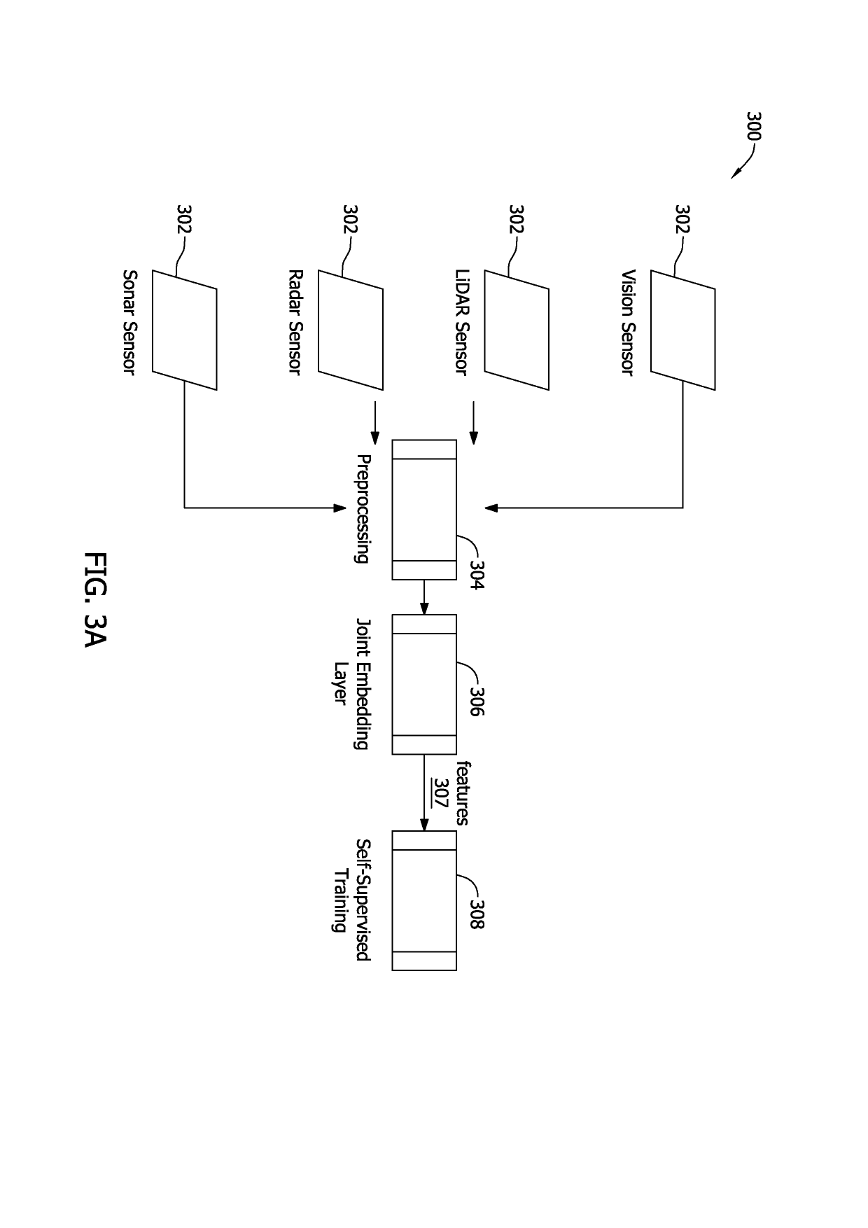

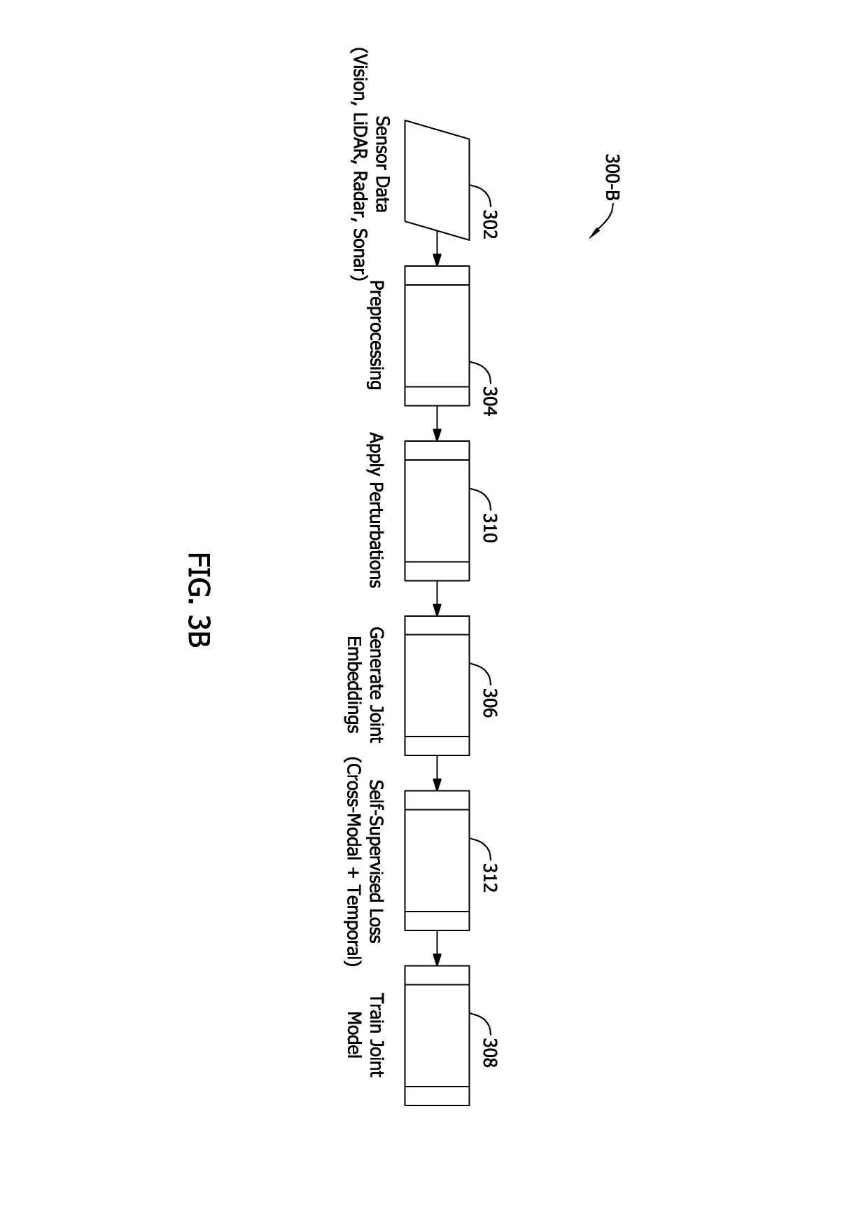

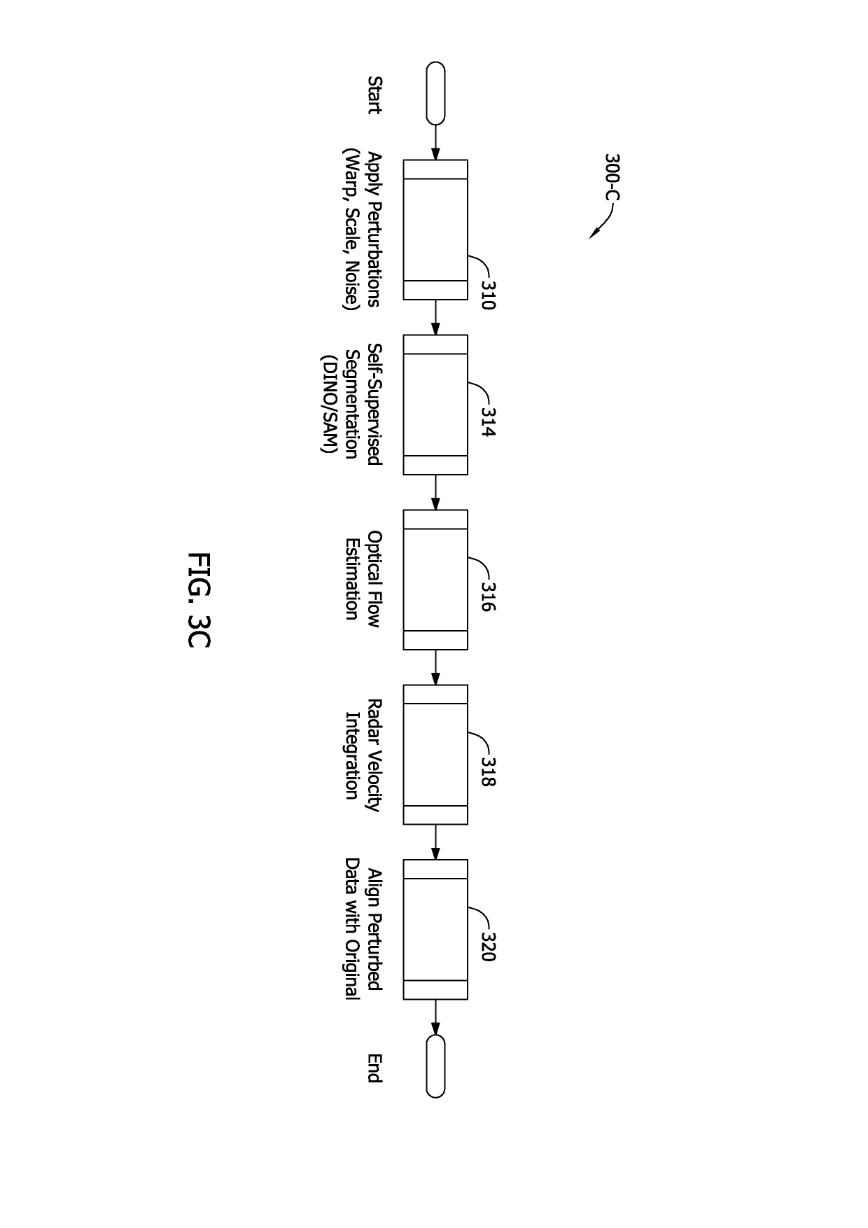

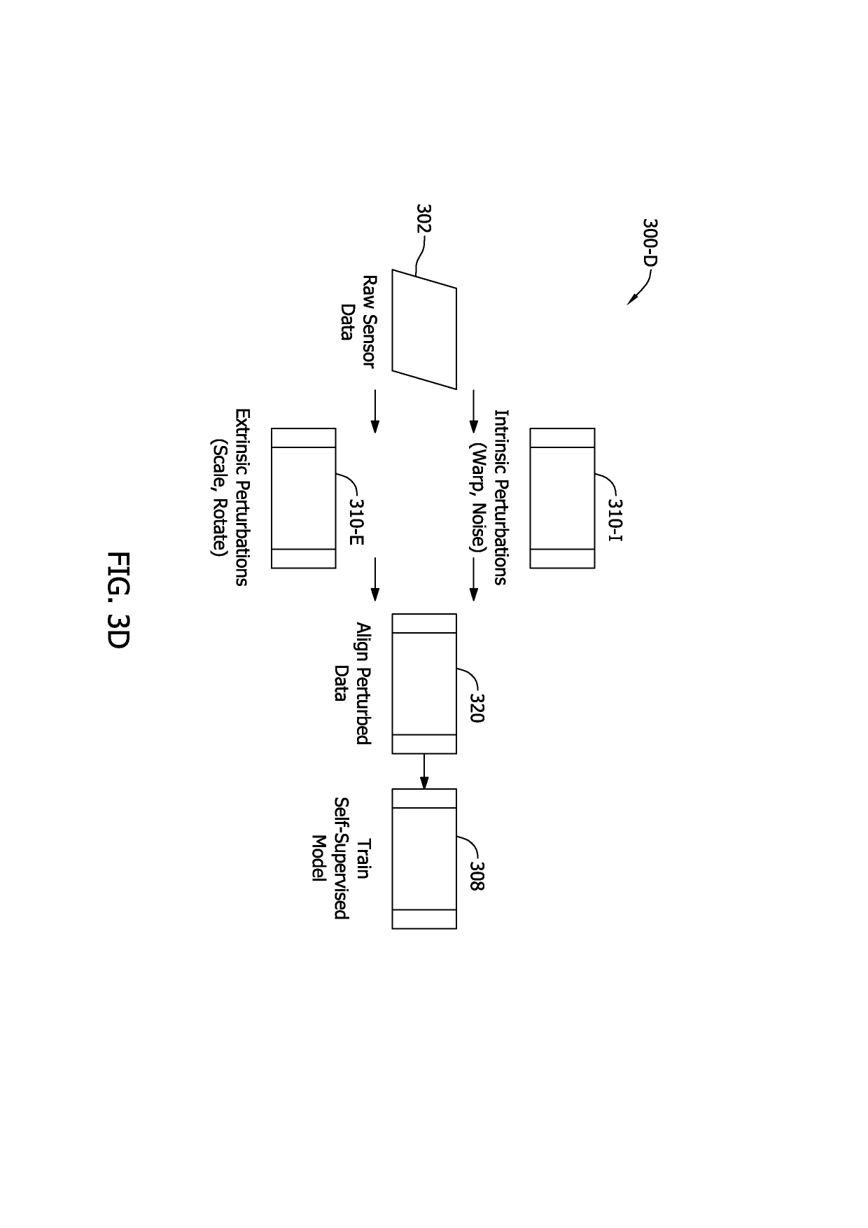

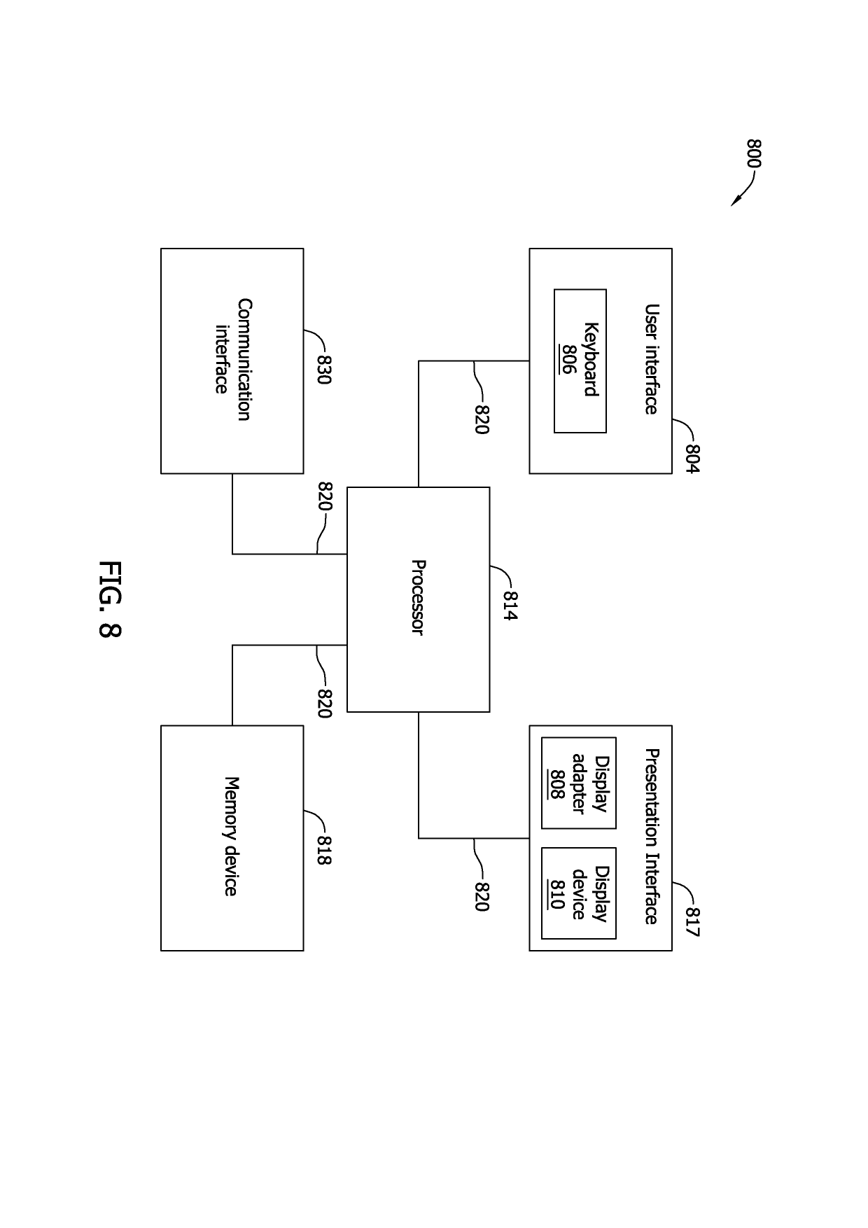

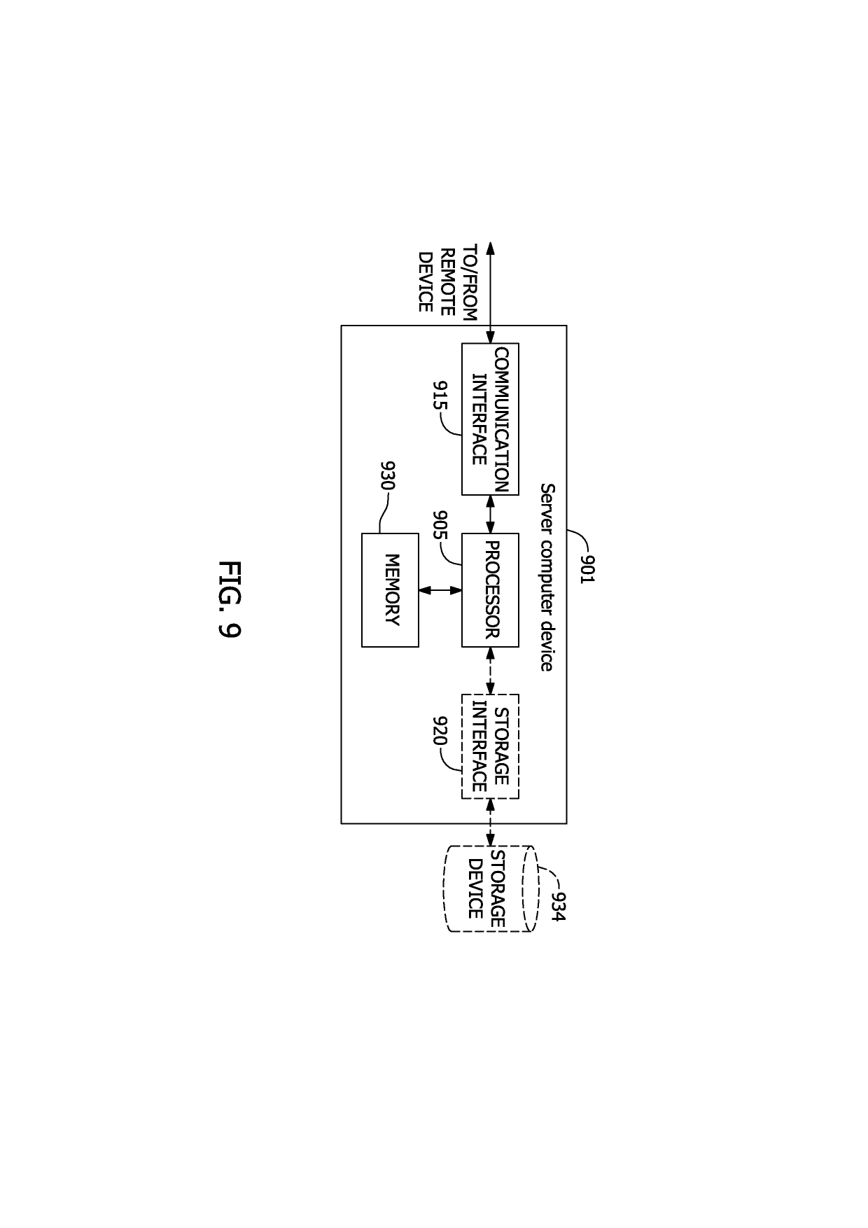

FIG. 3A shows an example method 300 for self-supervised training of a multi-modal embedding machine learning model 242. Method 300 may be implemented on autonomy computing device 700, a user computing device 800 (see FIG. 8, described later), and/or a server computing device 900 (see FIG. 9, described later). In the example embodiment, original sensor data 302 is received from one or more sensors. Original sensor data undergoes preprocessing 304 to, for example, crop and align the data prior to processing in a joint embedding layer of embedding machine learning model 242 to generate 306 original features. In some embodiments, preprocessing 304 is not applied to sensor data 302 and sensor data 302 are directly input into joint embedding layer.

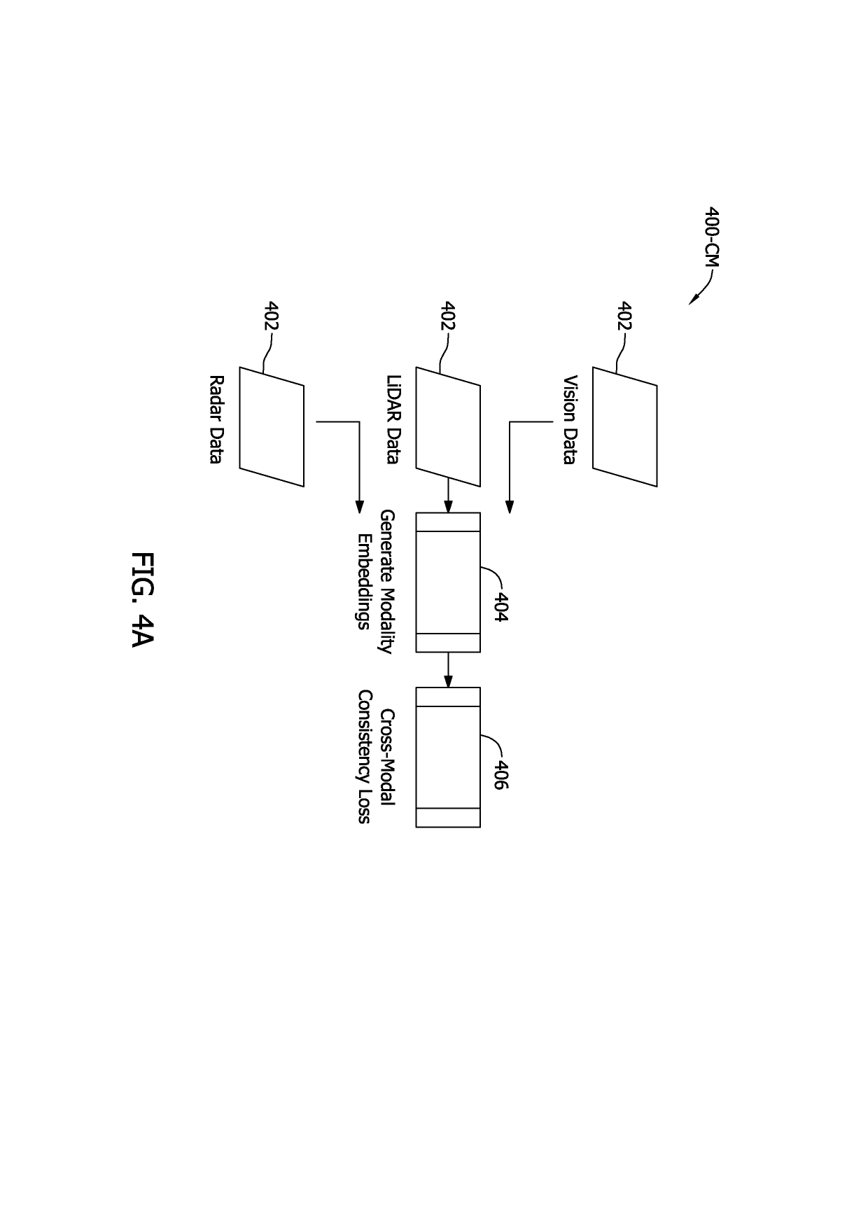

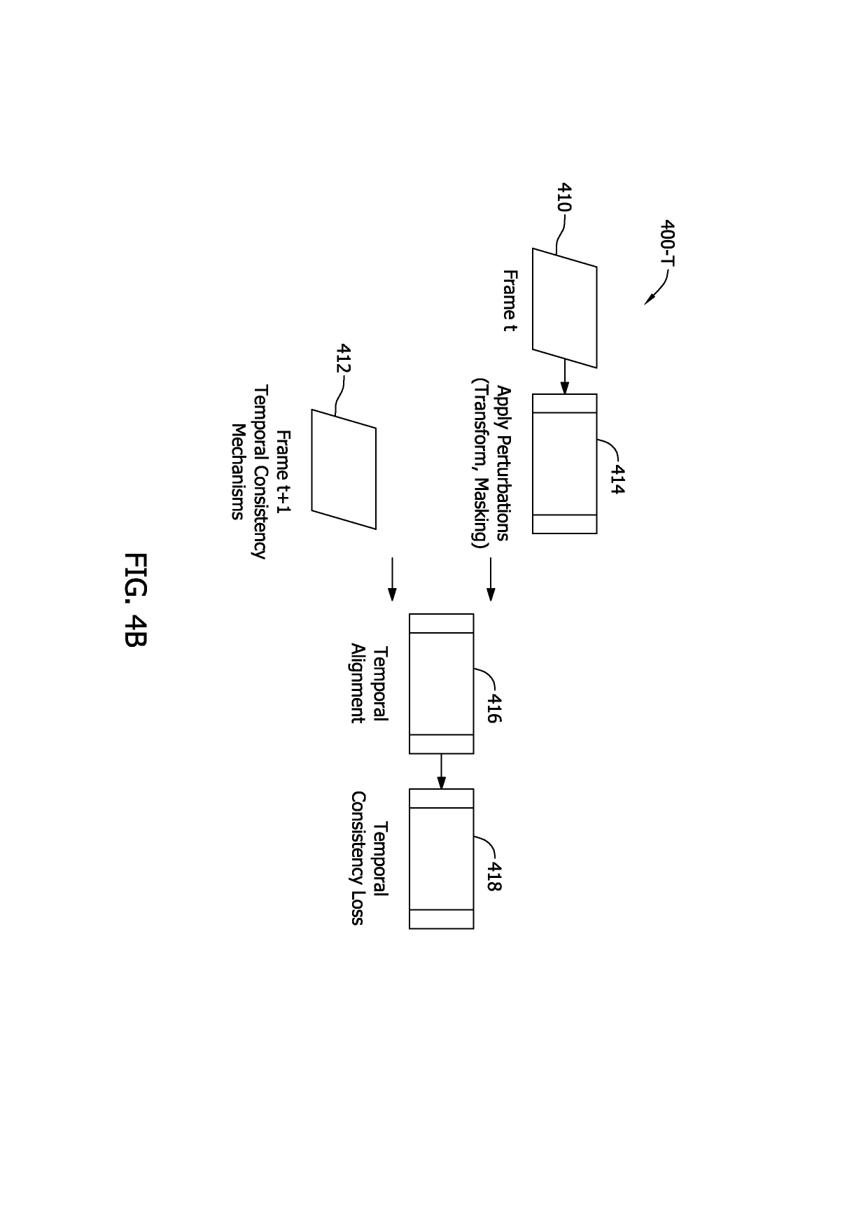

In the example embodiment, embedding machine learning model 242 is trained in a self-supervised manner based on the extracted features. As used herein, a machine learning model being trained in a self-supervised manner refers to the machine learning model being trained with reduced annotated or labeled data, wherein annotated or labelled data are data annotated or labeled, typically manually, with ground truths. In some embodiments, perturbations are applied to sensor data, and features are extracted from sensor data, with perturbations further applied to extracted features 307. Alternatively or additionally, perturbations may be applied to original features 307. As used herein, original data refers original sensor data acquired by sensors and/or original features detected by embedding machine learning model 242, without perturbations, while perturbed data refers to perturbed sensor data and/or perturbed features. As used herein, perturbations refer to noise or manipulation to data in the spatial dimension and/or the temporal dimension of the data. Embedding machine learning model 242 is trained 308 by aligning perturbed data with original data and adjusting the machine learning model while optimizing for a loss function. In other embodiments, embedding machine learning model 242 is trained via a self-supervised manner via multi-modality optical flow (see FIG. 3C, described later) and/or optimizing a cross-modal consistency loss function 400-cm penalizing cross-modal inconsistency (see FIG. 4A, described later), with or without perturbations being applied to sensor data 302 and/or features 307.

FIG. 3B shows an example embodiment of method 300-B of method 300 shown in FIG. 3A. Original sensor data 302 is received and preprocessed 304. Temporal and/or spatial perturbations are applied 310 to original sensor data. The perturbed and/or original sensor data are then used by joint embedding layer to generate 306 joint feature embeddings. The joint feature embeddings and/or perturbed sensor data are then used to calculate 312 a self-supervised loss function and train 308 the machine learning model by adjusting the machine learning model by optimizing for a cross-modal consistency and/or temporal consistency loss function.

In the example embodiment, method 300-B first includes receiving original sensor data 302 from one or more sensors of one or more modalities. For example, original sensor data 302 is received from vision sensors, LiDAR sensors, radar sensors, and/or sonar sensors. Vision sensors include sensors producing data in image formats, for example, cameras. Original sensor data 302 is received in a variety of formats, including both 2D and 3D, such as images and/or point clouds, respectively.

In the example embodiment, original sensor data is preprocessed 304 to format the data for future processing. Preprocessing 304 includes, for example, aligning, cropping, and/or transforming data.

In the example embodiment, perturbations are then applied 310 to original sensor data to simulate real-world noise, errors, and/or deviations. Perturbations include manipulating the data in both temporal and/or spatial domains. Spatial perturbations include manipulations made directly to original sensor data to transform a frame of the original sensor data, and include image warping, blurring, scaling, transforming, and/or adding noise to simulate real-world distortions. Temporal perturbations include manipulations made to simulate time-based occlusions or obstructions, including masking at least portions of data (e.g. applying a noise mask or color mask), shuffling the order of frames of data, and/or obscuring portions of data. The application of spatial perturbations is used to train the model to have increased resistance to real-world sensor occlusions, obstructions, and other issues, such as inclement weather, misalignment of sensors, poor lighting, or other issues that arise in the course of autonomous driving. The application of temporal perturbations train the model to have increased resistance to real-world time-based issues, such as delayed receipt of sensor data resulting in shuffled frames, or occlusion or temporary misfunction resulting in occluded portions of data. By applying 310 perturbations to original data, because perturbations are known, the perturbations are used as ground truth in training embedding machine learning model 242, thereby training the machine learning model to be resistant to real-world issues while reducing the need for manual data labeling.

In the example embodiment, after perturbations are applied, a joint embedding layer generates 306 joint embeddings based on the perturbed sensor data and/or original sensor data. Generation 306 of joint embeddings includes extracting features from sensor data, clustering features from sensor data, and/or identifying meaningful regions in sensor data. Original features are generated 306 based on original sensor data from multiple modalities. Perturbed features are generated based on perturbed sensor data. In some embodiments, the joint embedding layer applies spatial and/or temporal perturbations to the original features to generate perturbed features. Original features that may be perturbed include any features extracted from data, for example, bounding boxes and/or region proposals. In some embodiments, the extracted features may be output as a feature vector, with a point of the feature vector including all feature information extracted from each modality. Features 407 may include at least, for example, depth information, velocity information, observation duration information, semantic classification, and/or time stamps.

In the example embodiment, method 300-B further includes calculating 312 a loss function based on original sensor data, perturbed sensor data, original features, and/or perturbed features. Calculation 312 of self-supervised loss function includes calculating a cross-modal loss function and/or a temporal loss function. The cross-modal loss function represents discrepancies between different modalities – for example, if data and/or features from cameras does not agree with data and/or features from LiDAR, there would be cross-modal loss. The temporal loss function represents discrepancies in object trajectories or scene element positions over time.

In the example embodiment, a self-supervised training module then trains 308 the machine learning model based on the calculated loss function to improve the model’s resistance to perturbations. Training 308 the machine learning model includes aligning the perturbed data with the original data while adjusting the machine learning model to optimize the loss function. Optimizing for the cross-modal loss function includes adjusting embedding machine learning model to penalize discrepancies between features generated by different sensor modalities for the same scene, and aligns complementary knowledge and detections from different modalities, , thereby improving the models robustness in various environments including challenging conditions (e.g., poor lighting, inclement weather, or reflective environments). Optimizing for the temporal loss function includes adjusting embedding machine learning model to penalize discrepancies or changes in object trajectories and/or scene element positions over time, improving the model’s ability to identify stable, long-term features while ignoring transient artifacts, thereby improving tracking and reducing flickering in predictions.

FIG. 3C shows a flow chart of an example method 300-C showing generating 306 a joint embedding (see FIG. 3B) that includes one or more self-supervised mechanisms. In the example embodiment, method 300-C includes applying 310 perturbations to original sensor data, implementing one or more self-supervised mechanism, such as performing self-supervised segmentation 314 to extract features, calculating 316 an optical flow estimate, and/or integrating 318 radar and/or LiDAR information. Method 300-C further includes aligning 320 perturbed data with original data.

In the example embodiment, the system then generates joint embeddings by performing self-supervised segmentation 314 to extract features from original sensor data and/or perturbed sensor data. Self-supervised segmentation 314 extracts original features from original sensor data across multiple modalities. For example, self-supervised segmentation may include clustering features by aligning outputs from augmented or perturbed versions of the same data, thereby training the machine learning model to generalize to unseen scenarios. Alternatively or additionally, self-supervised segmentation 314 includes a segment anything model (SAM), where features are identified without manual annotation.

In the depicted embodiment, an optical flow is used to train embedding machine learning model 242 in a self-supervised manner. Optical flow is calculated 316 based on the original sensor data from vision sensors. Embedding machine learning model 242 is trained in a self-supervised manner by optimizing the loss function incorporating the optical flow. Using optical flow is advantageous in detecting moving objects in the environments. Features, such as moving objects, detected using optical flow in sensor data from vision sensors may be projected to the frame of reference of other modalities to derive projected features. The projected features may be used to train embedding machine learning model 242 by penalizing cross-modal inconsistency between the projected features of the other modalities and the features detected by embedding machine learning model 242 based on the sensor data from the other modalities. For example, the modality of vision sensors is camera, and the other modality is LiDAR (e.g., LiDAR occupancy data). Features detected based on optical flow in camera data may be projected onto the frame of reference in LiDAR. The projected LiDAR features and detected LiDAR features by embedding machine learning model 242 based on LiDAR sensor data are used in training embedding machine learning model 242 by optimizing the cross-modal discrepancy between the projected LiDAR features and the detected LiDAR features. In the example embodiment, radar and/or LiDAR data from original sensor data are used as ground truth. Radar velocity data provides precise velocity of moving objects, and may be used as ground truth for velocity of the features. LiDAR data provides precise spatial locations of features, and may be used as ground truth for spatial locations of features.

In the example embodiment, perturbed data are then aligned 320 with original data to train embedding machine learning model 242. For example, perturbations are applied to original sensor data to derive perturbed sensor data. Features of the perturbed sensor data detected by embedding machine learning model 242 are transformed back to the frame of reference of the sensor data to derive transformed-back perturbed sensor data. Because the perturbations applied to the sensor data are known, the perturbations may be removed from the transformed-back perturbed sensor data to derive unperturbed sensor data. Using perturbations being noise as an example, original sensor data is perturbed by adding noise to the original sensor data, and unperturbed sensor data is derived by removing the known noise from the transformed-back perturbed sensor data. The perturbations serve as ground truth in training embedding machine learning model 242 by adjusting embedding machine learning model 242 in minimizing the differences between the unperturbed sensor data with the original sensor data. In another example, perturbations are applied to features. Perturbed features are transformed back to the frame of reference of the sensor data to derive transformed-back sensor data. The transformed-back sensor data are input into embedding machine learning model 242 to derive transformed-back perturbed features. Perturbations are removed from the transformed-back perturbed features to derive unperturbed features. Embedding machine learning model 242 is trained by minimizing the differences between the unperturbed features and the original features. Using perturbations teaches the model to account for the noise and/or anomalies, improving performance in challenging conditions and increasing robustness to variations in sensors or environmental changes.

FIG. 3D shows an example method 300-D of the perturbation and alignment process of data as shown in FIG. 3B. Intrinsic perturbations are applied 310-I to original data and/or original features. Extrinsic perturbations may also be applied 310-E to original data and/or original features. Intrinsic perturbations include manipulations made to original sensor data , including image warping, blurring, and/or noise addition to simulate real-world distortions. Extrinsic perturbations include manipulations made to original features, including rotations, translations, and/or scaling of the features and/or adding noise to the features. In some embodiments, only one of intrinsic or extrinsic perturbations are applied.

In the example embodiment, perturbed data is then aligned 320 with original data to train embedding machine leaning model 242, as described with respect to FIG. 3C. .

FIG. 4A shows an example method 400-CM of calculating the cross-modal consistency loss function used in the method shown in FIG. 3B. After original sensor data of multiple modalities is received 402 (e.g., vision, LiDAR, and radar), original features are generated 404 from multiple modalities based on the original sensor data to produce joint feature embeddings, as described above with respect to FIG. 3B.

In the example embodiment, the cross-modal consistency loss function is calculated 406 to penalize inconsistencies between the modalities in a shared embedding space for the same scene. An inconsistency is any variation between produced data and ground truth data. For example, if vision data shows a “car” feature at a particular point, but the LiDAR data indicates that same particular point is a “pedestrian”, then the cross-modal consistency loss function penalizes this discrepancy between the modalities. In some embodiments, the loss function may assign a higher loss weight in the loss function to particular objects or areas (e.g., pedestrians, vehicles) that are identified by optical flow and/or semantic segmentation to encourage the model to identify selected scene elements with a higher degree of certainty. The altered loss weight is assigned based on the semantic class of the object. By penalizing cross-modal inconsistencies using the loss function, the machine learning model is trained to produce accurate features between modalities, encouraging the machine learning model to learn complementary and consistent features form all inputs. This improves the model’s robustness in challenging conditions, such as inclement weather, poor lighting, or in highly reflective environments.

FIG. 4B shows an example method 400-T for calculating the temporal consistency loss function used in the method shown in FIG. 3B. First, original data and/or original embeddings are received. For example, first frame data at frame t is received 410 and second frame data at frame t+1 is received 412. The frames may be sequential temporally, such that the second frame is received after the first frame. Then, perturbations are applied 414 to first frame data, such as transforming, occluding (e.g. covering portions of data), and/or masking the frame data. The first frame data and second frame data are aligned 416 and a temporal consistency loss function is calculated 418 based on detected inconsistencies between the first frame data and the second frame data. Inconsistencies may include, for example, abrupt changes in object trajectories or scene element positions, or velocity features that do not agree between produced features and ground truth (e.g. radar velocity data). Temporal consistency loss function teaches the machine learning model to predict future frames while removing temporal inconsistency caused by occlusion, sensor errors, or changes in the environment. In some embodiments, temporal consistency loss function and perturbations may be performed across more than two frames, such as by shuffling the order of three or more frames.

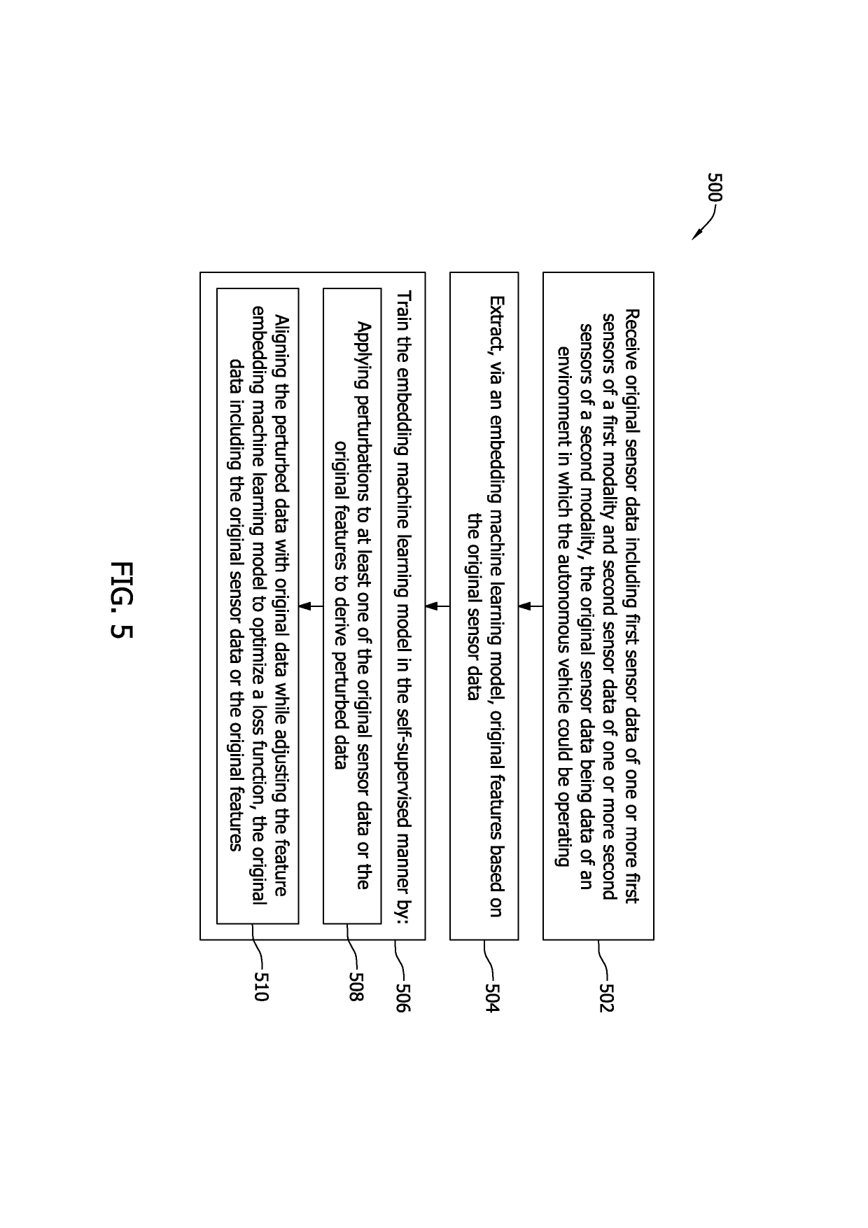

FIG. 5 is a method flowchart showing an example method 500 of training an embedding machine learning model of an autonomous vehicle in a self-supervised manner.

Method 500 includes receiving 502 original sensor data including first sensor data of one or more first sensors of a first modality and second sensor data of one or more second sensors of a second modality, the original sensor data being data of an environment in which the autonomous vehicle could be operating.

Method 500 further includes extracting 504, via the embedding machine learning model, original features based on the original sensor data.

Method 500 further includes training 506 the embedding machine learning model in the self-supervised manner by applying 508 perturbations to at least one of the original sensor data or the original features to derive perturbed data and aligning 510 the perturbed data with original data while adjusting the feature embedding machine learning model to optimize a loss function, the original data including the original sensor data or the original features.

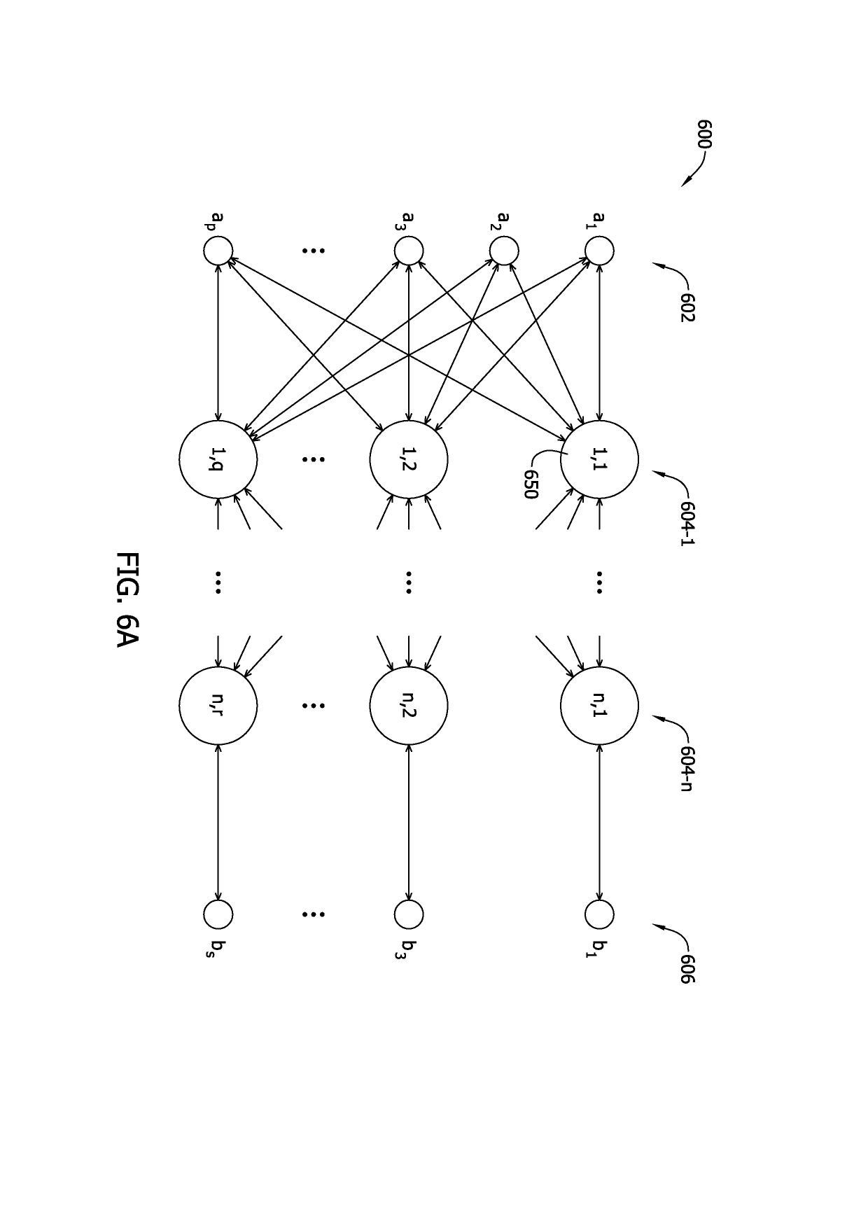

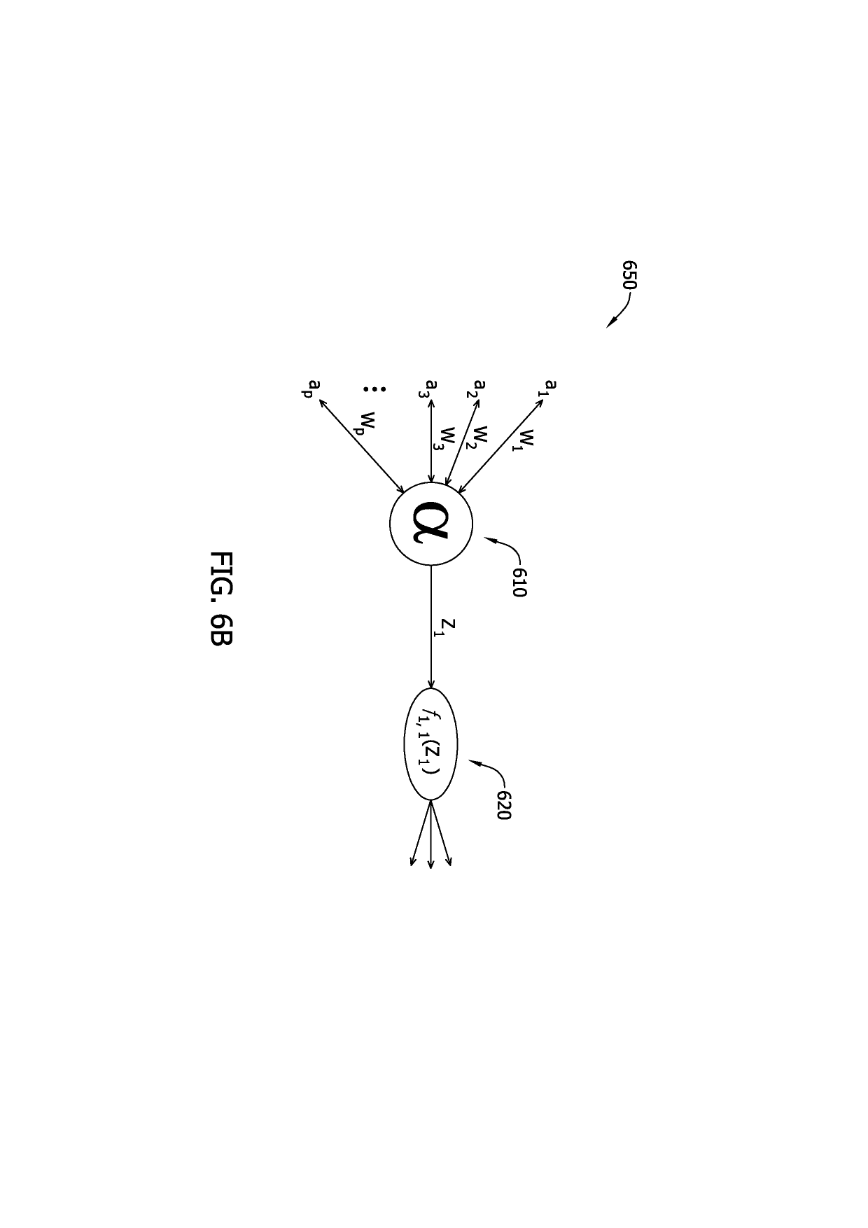

FIG. 6A depicts an example artificial neural network model 600. Methods 300, 400, and 500, and embedding machine learning model 242 may be implemented with one or more neural networks 600. The example neural network model 600 includes layers of neurons 650, 604-1 to 604-n, and 606, including an input layer 602, one or more hidden layers 604-1 through 604-n, and an output layer 606. Each layer may include any number of neurons, i.e., q, r, and n in FIG. 6A may be any positive integer. It should be understood that neural networks of a different structure and configuration from that depicted in FIG. 6A may be used to achieve the methods and systems described herein.

In the example embodiment, the input layer 602 may receive different input data. For example, the input layer 602 includes a first input a₁ representing training images, a second input a₂ representing patterns identified in the training images, a third input a₃ representing edges of the training images, and so on. The input layer 602 may include thousands or more inputs. In some embodiments, the number of elements used by the neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from the input layer 602, and/or one or more outputs from neurons in one of the previous hidden layers, to generate a decision or output. The output layer 606 includes one or more outputs each indicating a label, confidence factor, weight describing the inputs, and/or an output image. In some embodiments, however, outputs of the neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer analyzes the second dimension, and the final layer analyzes the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 6A, according to one embodiment. Each of the inputs to the neuron 650 (e.g., the inputs in the input layer 602 in FIG. 6A) is weighted such that input a₁ through aₚ corresponds to weights w₁ through wₚas determined during the training process of the neural network model 600.

In some embodiments, some inputs lack an explicit weight, or have a weight below a threshold. The weights are applied to a function α (labeled by a reference numeral 610), which may be a summation and may produce a value z₁ which is input to a function 620, labeled as f _{1,1}(z₁). The function 620 is any suitable linear or non-linear function. As depicted in FIG. 6B, the function 620 produces multiple outputs, which may be provided to neuron(s) of a subsequent layer, or used as an output of the neural network model 600. For example, the outputs may correspond to index values of a list of labels, or may be calculated values used as inputs to subsequent functions.

It should be appreciated that the structure and function of the neural network model 600 and the neuron 650 depicted are for illustration purposes only, and that other suitable configurations exist. For example, the output of any given neuron may depend not only on values determined by past neurons, but also on future neurons.

The neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing – either individually or in combination. The machine learning programs may also include natural language processing, semantic analysis, automatic reasoning, and/or machine learning.

Based upon these analyses, the neural network model 600 may learn how to identify characteristics and patterns that may then be applied to analyzing image data, model data, and/or other data. For example, the model 600 may learn to identify features in a series of data points.

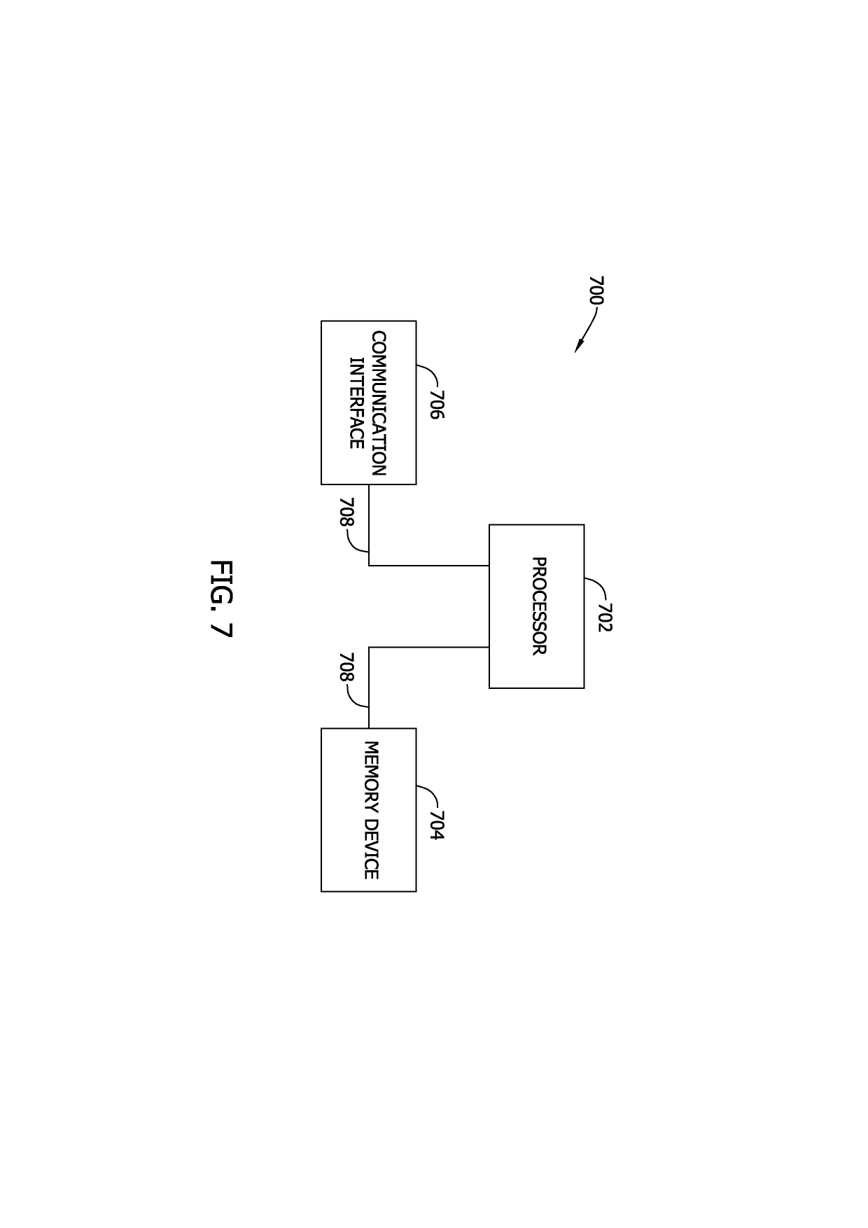

FIG. 7 is a block diagram of an example computing device 700. Autonomy computing system 200 and embedding machine learning model 242 may be implemented with one or more computing devices 700. Computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. In the example embodiment, the processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

FIG. 8 is a block diagram of an example user computing device 800. Systems and methods described herein may be implemented with one or more user computing devices 800 and software implemented therein. In the example embodiment, computing device 800 includes a user interface 804 that receives at least one input from a user. User interface 804 may include a keyboard 806 that enables the user to input pertinent information. User interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 800 includes a presentation interface 817 that presents information, such as input events and/or validation results, to the user. Presentation interface 817 may also include a display adapter 808 that is coupled to at least one display device 810. More specifically, in the example embodiment, display device 810 may be a visual display device, such as a cathode ray tube (CRT), a liquid crystal display (LCD), a light-emitting diode (LED) display, and/or an “electronic ink” display. Alternatively, presentation interface 817 may include an audio output device (e.g., an audio adapter and/or a speaker) and/or a printer.

Computing device 800 also includes a processor 814 and a memory device 818. Processor 814 is coupled to user interface 804, presentation interface 817, and memory device 818 via a system bus 820. In the example embodiment, processor 814 communicates with the user, such as by prompting the user via presentation interface 817 and/or by receiving user inputs via user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are for illustration purposes only, and thus are not intended to limit in any way the definition and/or meaning of the term “processor.”

In the example embodiment, memory device 818 includes one or more devices that enable information, such as executable instructions and/or other data, to be stored and retrieved. Moreover, memory device 818 includes one or more computer readable media, such as, without limitation, dynamic random access memory (DRAM), static random access memory (SRAM), a solid state disk, and/or a hard disk. In the example embodiment, memory device 618 stores, without limitation, application source code, application object code, configuration data, additional input events, application states, assertion statements, validation results, and/or any other type of data. Computing device 800, in the example embodiment, may also include a communication interface 830 that is coupled to processor 814 via system bus 820. Moreover, communication interface 830 is communicatively coupled to data acquisition devices.

In the example embodiment, processor 814 may be programmed by encoding an operation using one or more executable instructions and providing the executable instructions in memory device 818. In the example embodiment, processor 814 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

FIG. 9 illustrates an example configuration of a server computer device 901. Systems and methods described herein may be implemented with one or more server computer devices 901. In the example embodiment, server computer device 901 also includes a processor 908 for executing instructions. Instructions may be stored in a memory area 930, for example. Processor 908 may include one or more processing units (e.g., in a multicore configuration).

Processor 908 is operatively coupled to a communication interface 917 such that server computer device 901 is capable of communicating with a remote device or another server computer device 901. For example, communication interface 917 may receive data from a system such as autonomy computing system 200, via the Internet.

Processor 908 may also be operatively coupled to a storage device 934. Storage device 934 is any computer-operated hardware suitable for storing and/or retrieving data. In some embodiments, storage device 934 is integrated in server computer device 901. For example, server computer device 901 may include one or more hard disk drives as storage device 934. In other embodiments, storage device 934 is external to server computer device 901 and may be accessed by a plurality of server computer devices 901. For example, storage device 934 may include multiple storage units such as hard disks and/or solid state disks in a redundant array of independent disks (RAID) configuration. storage device 934 may include a storage area network (SAN) and/or a network attached storage (NAS) system.

In some embodiments, processor 908 is operatively coupled to storage device 934 via a storage interface 920. Storage interface 920 is any component capable of providing processor 908 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 908 with access to storage device 934.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium. A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing – either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) reducing time and costs from manual annotation in developing multi-modal autonomous computing systems, (b) increasing robustness of feature generation models, (c) production of unified multi-modal feature embeddings that leverage the strengths of each modality to improve robustness, (d) improving autonomous computing systems performance in challenging environments (e.g. high reflectivity, low visibility, inclement weather), and (f) reducing duplicate work in labeling multi-modal data for feature generation models.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for training a multi-modal embedding machine learning model of an autonomous vehicle, the method comprising:
training an embedding machine learning model of an autonomous vehicle in a self-supervised manner by:
receiving original sensor data including first sensor data of one or more first sensors of a first modality and second sensor data of one or more second sensors of a second modality, the original sensor data being data of an environment in which the autonomous vehicle could be operating;
extracting, via the embedding machine learning model, original features based on the original sensor data; and
training the embedding machine learning model in the self-supervised manner by:
applying perturbations to at least one of the original sensor data or the original features to derive perturbed data; and
aligning the perturbed data with original data while adjusting the embedding machine learning model to optimize a loss function, the original data including the original sensor data or the original features.

2. The method of claim 1, wherein applying the perturbations further comprises applying intrinsic perturbations to the original sensor data.

3. The method of claim 1, wherein applying the perturbations further comprises applying extrinsic perturbations to the original features.

4. The method of claim 1, wherein applying the perturbations further comprises applying temporal perturbations to at least one of the original sensor data or the original features.

5. The method of claim 1, wherein the loss function includes a cross-modal consistency loss function, training the embedding machine learning model further comprising optimizing the cross-modal consistency loss function by penalizing a cross-modal inconsistency between original features of the first modality and the second modality in the cross-modal consistency loss function.

6. The method of claim 1, wherein the loss function includes a temporal consistency loss function, training the embedding machine learning model further comprising optimizing the temporal consistency loss function by penalizing a temporal inconsistency in the loss function.

7. The method of claim 1, wherein training the embedding machine learning model further comprises assigning a loss weight to an object based on a semantic class of the object in the loss function.

8. The method of claim 1, wherein the one or more first sensors include one or more cameras, the method further comprising:
extracting original features of the first modality based on an optical flow in the first sensor data;
extracting, via the embedding machine learning model, original features of the second modality based on the second sensor data;
generating projected features of the second modality by projecting the original features of the first modality into the second modality; and
adjusting the embedding machine learning model to optimize the loss function by penalizing cross-modal inconsistency between the projected features of the second modality and the original features of the second modality.

9. The method of claim 1, wherein the method further comprises:
training the embedding machine learning model by using velocity data from one or more radio detection and ranging (radar) sensors as ground truth of velocity of objects.

10. The method of claim 1, wherein the method further comprises:
training the embedding machine learning model by using occupancy data from one or more light detection and ranging (LiDAR) sensors as ground truth of occupancy of objects.

11. A training computing device for training a multi-modal embedding machine learning model of an autonomous vehicle, the training computing device comprising at least one processor in communication with at least one memory device, the at least one processor programmed to:
train an embedding machine learning model of an autonomous vehicle in a self-supervised manner by:
receiving original sensor data including first sensor data of one or more first sensors of a first modality and second sensor data of one or more second sensors of a second modality, the original sensor data being data of an environment in which the autonomous vehicle could be operating;
extracting, via the embedding machine learning model, original features based on the original sensor data; and
training the embedding machine learning model in the self-supervised manner by:
applying perturbations to at least one of the original sensor data or the original features to derive perturbed data; and
aligning the perturbed data with original data while adjusting the embedding machine learning model to optimize a loss function, the original data including the original sensor data or the original features.

12. The training computing device of claim 11, wherein the at least one processor is further programmed to apply perturbations by applying intrinsic perturbations to the original sensor data.

13. The training computing device of claim 11, wherein the at least one processor is further programmed to apply perturbations by applying extrinsic perturbations to the original features.

14. The training computing device of claim 11, wherein the at least one processor is further programmed to apply perturbations by applying a temporal perturbation to at least one of the original sensor data or the original features.

15. The training computing device of claim 11, wherein the loss function includes a cross-modal consistency loss function, and the at least one processor is further programmed to train the embedding machine learning model by optimizing the cross-modal consistency loss function by penalizing a cross-modal inconsistency between original features of the first modality and the second modality in the cross-modal consistency loss function.

16. The training computing device of claim 11, wherein the loss function includes a temporal consistency loss function, and the processor is further programmed to train the embedding machine learning model by optimizing the temporal consistency loss function by penalizing a temporal inconsistency in the loss function.

17. The training computing device of claim 11, wherein the at least one processor is further programmed to train the embedding machine learning model by assigning a loss weight to an object based on a semantic class of the object in the loss function.

18. The training computing device of claim 11, wherein the one or more first sensors include one or more cameras, the processor being further programmed to:
extract original features of the first modality based on an optical flow in the first sensor data;
extract, via the embedding machine learning model, original features of the second modality based on the second sensor data;
generate projected features of the second modality by projecting the original features of the first modality into the second modality; and
adjust the embedding machine learning model to optimize the loss function by penalizing cross-modal inconsistency between the projected features of the second modality and the original features of the second modality.

19. At least one non-transitory computer-readable storage medium for training a multi-modal embedding machine learning model of an autonomous vehicle, the at least one non-transitory computer-readable storage medium comprising a plurality of instructions stored thereon that, in response to being executed, cause a system to:
train an embedding machine learning model of an autonomous vehicle in a self-supervised manner by:
receiving original sensor data including first sensor data of one or more first sensors of a first modality and second sensor data of one or more second sensors of a second modality, the original sensor data being data of an environment in which the autonomous vehicle could be operating;
extracting, via the embedding machine learning model, original features based on the original sensor data; and
training the embedding machine learning model in the self-supervised manner by:
applying perturbations to at least one of the original sensor data or the original features to derive perturbed data; and
aligning the perturbed data with original data while adjusting the embedding machine learning model to optimize a loss function, the original data including the original sensor data or the original features.

20. The least one non-transitory computer-readable storage medium of claim 19, wherein the plurality of instructions further cause the system to apply perturbations by applying at least one of intrinsic perturbations or extrinsic perturbations to the original data.
